(19) United States
(12) Patent Application Publication
(10) Pub. No.: US 2012/0117105 A1
(43) Pub. Date: May 10, 2012

(54) Collaborative Database Operations

(75) Inventors: Les Thomas, Los Gatos, CA (US); Eric Jacobson, San Jose, CA (US); Wesley Powell, San Jose, CA (US); Adam Ward, San Jose, CA (US); Edward L. Ford, Santa Clara, CA (US)

(73) Assignee: Apple Inc., Cupertino, CA (US)

(21) Appl. No.: 12/941,015

(22) Filed: Nov. 5, 2010

(51) Int. Cl. G06F 17/30

(52) U.S. Cl. 707/769; 707/E17.014

(57) ABSTRACT

Methods, program products, and systems implementing collaborative database operations are disclosed. Collaborative database operations can be facilitated by data notification, where a server notifies a client when data being viewed at the client are updated. Notification can be achieved through registration and polling. A client of a database can request data from a server. The request can include a data request and a registration request. The data request can include a query into a database. The registration request can include a specification on conditions upon which the client is to be notified. The condition can include an event type. Upon registration, the client can poll the server periodically to determine whether a result of the query has changed, and if so, what data record in the result has changed. If a data record has changed, the client can request the changed data using an identifier of the data record.

### TECHNICAL FIELD

This disclosure relates generally to data management.

### BACKGROUND

A client device, such as a smart phone, can execute various application programs that access one or more data stores. The application programs can include, for example, a database reporting program that is configured to display a formatted view of data stored in the one or more data stores, or a database editing program that is configured to update the data in the one or more data stores. The data stores can be hosted on server computers that are located remotely from the client device. For the application programs to access the data stores, the client device can utilize one or more connections to the data stores through a communications network.

The database editing program can be separate from the database reporting program. For example, a first group of users can have privilege to modify the data using the database editing program. A second group of users can have privilege to view the data using the database reporting program. The database reporting program can generate a data report by submitting a query to the data store. If the data in the data store are modified, the database reporting program can retrieve the modified data by resubmitting the query.

### SUMMARY

Methods, program products, and systems implementing collaborative database operations are disclosed. Collaborative database operations can be facilitated by data notification, where a server notifies a client when data being viewed at the client are updated. Notification can be achieved through registration and push or polling. A client of a database can request data from a server. The request can include a data request and a registration request. The data request can include a query into a database. The registration request can include a specification on conditions upon which the client is to be notified. The condition can include an event type. Upon registration, the client can poll the server periodically to determine whether result of the query has changed, and if so, what data record in the result has changed. If a data record has changed, the client can request the changed data using an identifier of the data record.

Upon receiving the data request and the registration request, the server can maintain a notification cache for the client. The notification cache can store data identifiers of data records requested by the client. Each data identifier can be associated with a type of an event that has occurred on the data record identified by the data identifier. The notification cache can be filtered according to the specification in the registration request. In response to a polling request from a client, the server can notify the client that a data record has been modified.

These and other implementations can be utilized to achieve one or more of the following advantages. Collaborative database operation techniques allow multiple users to work on a same database concurrently and collaboratively. A client can receive real time or near real time data updates by another client. The updates, including insertion, deletion, and modification of data, can be reflected on the client without requiring the client to execute a query (which can be complex) for a second time.

The details of one or more implementations of collaborative database operations are set forth in the accompanying drawings and the description below. Other features, aspects, and advantages of collaborative database operations will become apparent from the description, the drawings, and the claims.

### BRIEF DESCRIPTION OF THE DRAWINGS

FIG. 1 is a block diagram illustrating an exemplary system implementing techniques of collaborative database operations.

FIG. 2 is a block diagram illustrating an exemplary architecture of collaborative database operations.

FIG. 3 is a sequence diagram illustrating interactions between various components during notification registration.

FIG. 4 is a sequence diagram illustrating interactions between various subsystems and processes upon occurrence of a notification event.

FIG. 5 is a sequence diagram illustrating interactions between various subsystems and processes in response to a client notification poll.

FIG. 6 is flowchart illustrating an exemplary process implementing collaborative database operations on a server.

FIG. 7 is flowchart illustrating an exemplary process implementing collaborative database operations on a client.

FIG. 8 is a block diagram of an exemplary system architecture for implementing the collaborative database operations.

Like reference symbols in the various drawings indicate like elements.

### DETAILED DESCRIPTION

### Exemplary Database Collaboration Operations

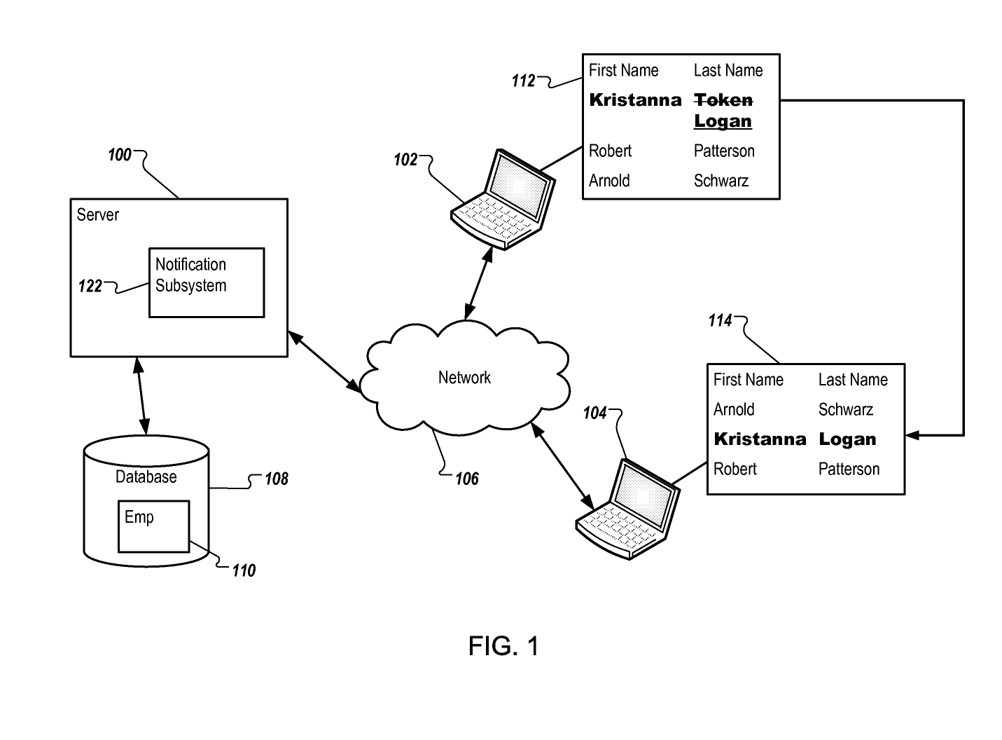

FIG. 1 is a block diagram illustrating an exemplary system implementing techniques of collaborative database operations. The exemplary system can include server 100, client 102, and client 104. Server 100, client 102, and client 104 can be connected using communications network 106.

Server 100 can host, or be connected to, relational database 108. Relational database 108 can store data in various tables. The data can be organized as collections. Each collection can include a set of data records. A collection can correspond to a table, or data grouped together from multiples (e.g., in response to a search request). Employee collection 110 can be a set on employee data records stored in relational database 108 as one or more tables. Each of client 102 and client 104 can include a database access program (e.g., a database editing program or a database reporting program) that can access the data stored in employee collection 110.

Client 102 can provide for display a portion of data stored in employee collection 110 in page 112. To display the data in page 112, client 102 can send a query (e.g., a SELECT statement in structured query language (SQL)) to retrieve the data. The retrieved data can be formatted using a first layout of the database access program executing on client 102 and be presented in page 112. Similarly, client 104 can present a portion of data stored in employee collection 110 in page 114. The portion of data presented in page 112 and the portion of data presented in page 114 can overlap (e.g., have common rows) but need not be identical.

Each of client 102 and client 104 can register with server 100 to receive notification. Notification functions implemented on server 100, client 102, and client 104 allow client 102 and client 104 to retrieve row updates from server 100, such that client 102 and client 104 can have up-to-date views of data in collection 110. On server 100, the notification functions can be implemented using notification subsystem 122. On client 102 and 104, the notification functions can be implemented using one or more data buffers and one or more polling subsystems. During registration by client 104, notification subsystem 122 can associate row identifiers (row IDs) of rows of data being displayed in page 114 with an update event such that when the update event occurs to a row of data represented by one of the row IDs, the row ID is marked. During a next poll by client 104, a query generated by server 100 can be executed to retrieve the updated row of data using the row ID and provide the updated data to client 104. The query generated by server 100 can be a high-performance query compared to the original query from client 104 for selecting data.

For example, client 104 has registered the data displayed in page 114 for notification based on update. Based on the registration, notification subsystem 122 associates the row IDs corresponding to the registered data and to client 104 with an update event in a cache. Client 102 can update a row of data to change an employee name “Kris Token” to “Kris Logan” in page 112. Notification subsystem 122 can mark the row ID corresponding to the row of data having employee name “Kris Token.” Client 104 can poll server 100 at specified intervals. In a poll after the change by client 102, client 104 can identify the marked row ID. Server 110 can perform a query using the row ID and send the result (“Kris Logan”) to client 104. The change of employee name from “Kris Token” to “Kris Logan” by client 102 can thus reflect in page 114 of client 104.

Updating a row of data, as described above, is one form of basic operations of notification. Variations of the basic operations are possible. For example, server 100 and client 104 can include paging functions allowing client 104 to store in a data identifier buffer all row IDs corresponding to a query, and in a data record buffer a portion of the data identified by some of the row IDs. The data record buffer can serve as a cache to allow paging operations (e.g., displaying a page of data before or after page 114). Paging operations allow a large result set of a query to be displayed in multiple pages without requesting the data from server 100 by executing the query multiple times. The data record buffer can store more rows of data than currently displayed in page 114. If a row of data that is cached in data record buffer is updated and the updated row of data is not currently displayed in page 114, a silent update can be performed in a next poll, where client 104 updates the data record buffer without affecting page 114. A “last update” date and time can be updated to reflect the update.

Operations of notification based on an update event can include conflict resolution. On client 102, a first user can change a data record from “Kris Token” to “Kris Logan” in page 112. On client 104, a second user can change the same data record from “Kris Token” to “Kris Termin” in page 114, after the first user has made the change. Client 104 can provide for display a dialog that presents options for the second user to overwrite the first user's change, accept the first user's change and discard the second user's change, accept the first user's change and merge the second user's change, or edit the second user's change.

Operations of notification based on update event can include sort order management. Page 114 can include a portion of data in employee collection 110. The portion of data can be sorted by first name. Data record “Kris Logan” is located in the portion of data displayed in page 114. On client 102, a user changes the record into “Zach Logan.” The change, although not necessarily changing a position of the record in a result set of the query retrieving data to client 104, can invalidate the sort order of the portion of data. To have the “Zach Logan” record placed in a proper place, data retrieved to client 104 can be re-sorted. If the change causes the record to fail a selection criterion in the query retrieving data to client 104, the record can remain in the result set.

In addition to notification based on update events as described above, notification can be based on other database operations including delete and insert. Notifications based on insert, delete, and update will be referred to as row notification. On client 102, a first user can delete a record from page 112. The record is being displayed in page 114 on client 104. Upon the deletion, client 104 can display a dialog box if the first user has selected viewing the record being deleted. The dialog box can indicate that data currently being viewed are deleted. When the dialog box is closed, the record can disappear from page 114. A next record can be moved up and displayed. Client 104 can act similarly even if the deleted record is already modified in page 114. If the record is not being displayed (e.g., the record is before a first row or after a last row of records currently being displayed in page 114), the deletion can be silent on client 104.

On client 102, a first user can insert a record into page 112. Behavior of client 104 in response to an insert notification can depend on a viewing mode. If data in displayed page 114 are retrieved in a selection mode, the inserted record can be excluded from the result set of the selection. If data in displayed page 114 are retrieved in a browse mode (e.g., when an entire collection is viewed), behavior of client 104 can depend on a sort order of the collection. If the collection is unsorted, and is being displayed sequentially in an ad hoc manner, the inserted record can be placed at the end of the collection. If the collection is sorted, the inserted record can be added to the end of the sorted collection. The current sort order can be invalidated. If there are not enough rows of records to fill page 114, the inserted record can be added to the end of currently displayed rows of records. If page 114 is full, client 104 can add a scrollbar or shift an existing scroll bar in size or position or both in response to the insertion.

In addition to row notification, association notification and schema notification are possible. In association notification, a row of record being displayed in page 114 can be associated with other data (e.g., data records or files). For example, an “employee” record “Arnold Schwarz” can be associated with one or more “event” records, e.g., “Picnic,” “Birthday Party,” and “Training.” The association can be represented by configurable metadata. At occurrence of the association, a notification can be made. An association notification can cause the configurable metadata to be updated in addition to causing the data records to be updated. In a schema notification, a notification can be sent when a database schema is updated. For example, when a table, an index, a sequence, or a view is created, modified, or dropped, a notification can be sent.

If, for example, on client 102, the “Picnic” record is changed to “BBQ,” an event view associated with record “Arnold Schwarz” can be updated silently on client 104 upon an update notification. If, on client 102, the “Birthday Party” record is deleted, the record “Birthday Party” can be silently removed from an association list on client 104. If a record “Arnold Schwarz” of “employee” records is being displayed in page 114 on client 104, and a user deletes an association between “Arnold Schwarz” and an event record “Birthday Party” on client 102, the record “Birthday Party” can be silently removed from an event association list for “Arnold Schwarz” on client 104. If a record “Arnold Schwarz” is being displayed in page 114 on client 104, and an event record “Training” is added by a user on client 102, the event record “Training” can be silently added to the bottom of an association between an association list of employee collection 110.

### Exemplary Database Collaboration System

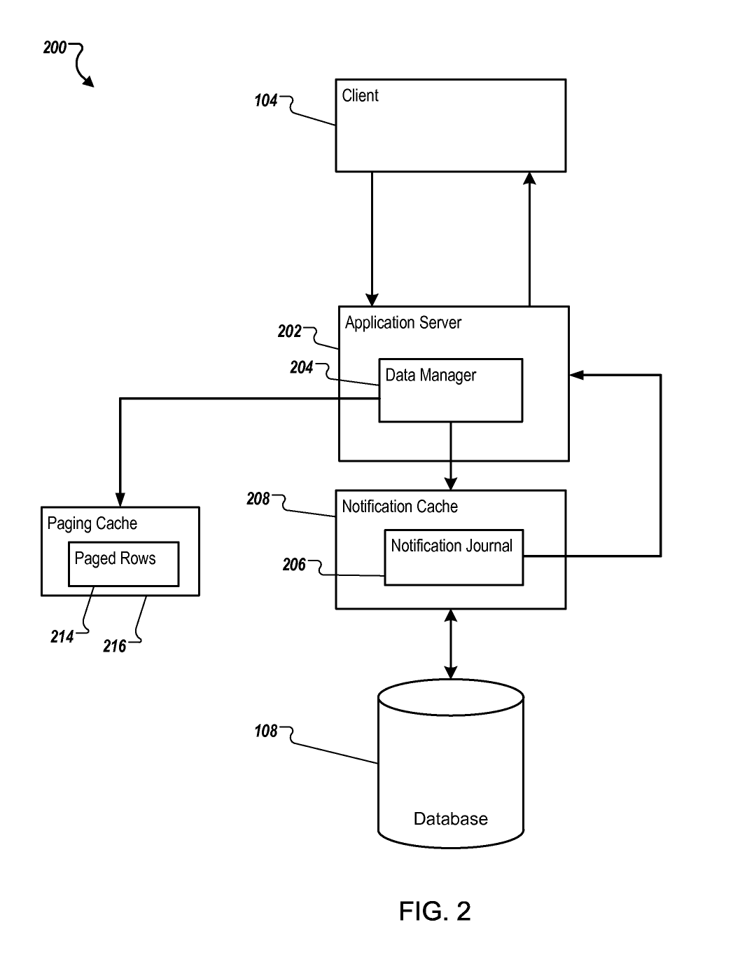

FIG. 2 is a block diagram illustrating an exemplary architecture of collaborative database operations. The architecture can include system 200 that includes various components. Client 104 can register for notification at application server 202. Application server 202 can include data manager 204 for performing database related operations. Application server 202, as well as various caches that will be described in further details below, can be components of notification subsystem 122 as described above in reference to FIG. 1.

To register for notification, client 104 can send notification parameters to application server 202 in a registration request. In response, application server 202 can create notification journal 206. Parameters for creating notification journal 206 can include a client identifier identifying the client and the notification request. Notification journal 206 can be associated with the client identifier and be client-specific. Notification journal 206 can include a serial log of data updates made to a given collection specified in the notification request. If a data event occurs, e.g., a new row is added to the collection, or if an existing row is updated or deleted, a new journal entry can be entered into notification journal 206. Application server 202 can give client 104 a point-in-time marker to client 104 when client 104 makes the registration request or a subsequent polling request. The point-in-time marker can be used by client 104 and application server to identify rows of data from notification journal 206 based on time and event type. Based on notification registration, database 108 can write row IDs and associated events (e.g., insertions, deletions, and updates) a specified client (e.g., client 104) into notification journal 206.

Notification journal 206 can be stored in notification cache 208. Notification cache 208 can be maintained in a distributed caching system (e.g., MemCached®). Notification cache 208 can be implemented separately from application server 202 and from a database server hosting database 108. Notification cache 208 can keep notification journal 206 for all registered clients. Notification cache 208 can be managed by a watchdog utility (e.g., Monit®).

Data manager 204 can determine which row of a collection to send to client 104 in a notification in response to a polling request from client 104. The determination can be made using notification journal 206 and paged rows 214. Paged rows 214 can include rows currently marked as active (e.g., rows that are being displayed or being stored in a data record cache) on client 104. Paged rows 214 can be stored in paging cache 216, which can be maintained together with notification cache 208 or separately from notification cache 208.

Components of exemplary system are described above. In some implementations, interaction between the components can occur as follows. Client 104 can make a data request on a given collection using a page request. A page request can include a query and a query context, the query context specifying which portion of a result set of the query is to be sent back to client 104. Row IDs of other portions of the result set, rather than actual data, can be sent back to client 104. The page request can include or be associated with a registration request.

In response to the page request, application server 202 can send the portion of the result set, the row IDs, and a notification handle to client 104. The notification handle can include a point-in-time marker data update in notification journal 206.

After sending the registration request, client 104 can start polling. Polling can include sending a polling request periodically (e.g., every minute) to get collection update. An example list of parameters of the polling request is shown below in Table 1.

TABLE 1
Polling Request Parameters

| Parameter Name | Type | Description |
|---|---|---|
| notificationHandle | int | A notification handle that includes a point- |
| | | in-time marker for requesting rows after |
| | | the point-in-time |
| notificationType | long | A type of notifications to receive |
| collectionId | int | Collection ID of the collection |
| sessionId | String | Session ID of a current user session |

The notificationType parameter can include a bitmap specifying the type or types of events. For example, 0x01 can represent an insert event. 0x02 can represent an update event. 0x04 can represent a delete event. 0x08 can represent a view event. Notifications can be bundled. For example, 0x06 can represent an update event and delete event; 0x07 can represent an insert, update, and delete event; 0x0F can represent an insert, update, delete, and view event. The notificationType parameter can be specified for client 104 at registration time or at polling time. Client 104 can use the notificationType parameter to specify a type of events or a bundle of multiple types of events. For example, client 104 can register to receive only updates, or only inserts and deletes. In some implementations, events that have opposite effects can be matched and coalesced. For example, if a newly inserted row of data is deleted, the insert event and the delete event can cancel out. A first update event on a row of data can be coalesced with a second update event on the row of data. Matching and coalescing events can improve notification efficiency and be used as mechanisms for optimization.

In response to the polling request, application server 202 can return a notification result object. The notification result object can include a new notification handle. The notification result object can include a list of notification entries. Each notification entry can include a row ID and an event type.

Upon receiving the notification result object, client 104 can traverse the list of notification entries. Client 104 can select a row ID that is to be updated, based on a current page view (e.g., a page view of page 114 of FIG. 1) and an event type (insert, update, or delete). Client 104 can send a request to get a collection row by row ID, using one or more selected row IDs. In response, application server 202 can send a list of collection rows.

Client 104 or another client can change data in database 108 by inserting, updating, or deleting rows of data in a collection. Client 104 can send an add row, update row, or delete row request, respectively. The requests can each specify a collection identifier and new data values, if any. The data are updated in database 108. In addition, application server 202 creates a new notification entry including row ID and an event type. Application server 202 can insert the new notification entry into notification journal 206 and increment the notification handle (e.g., by one). Application server 202 can send the updated row back to client 104 in response to the request.

Application server 202 can specify a life span (e.g., two hours) for the notification entry inserted into notification journal 206. Application server 202 can periodically perform a purge on notification journal 206 to remove notification entries that have been in notification journal 206 for a time period that is greater than the specified life span. If a purge on a notification entry occurs before a polling request, application server 202 can return an invalid notification handle exception. Client 104 can re-submit a query and re-register the notification in response to the exception.

The notification entries can be stored as key, value pairs in notification journal 206. The key can be a page key unique per tenant (e.g., a work group of clients), per client, and per page (e.g., a specified group of rows of data). The value can be a list of notification entries. The page can have a configurable page size (e.g., 100 rows of data). Each page key can be set to expire upon reaching the life span since the list of notification entries was last modified. For example, if 200 notification entries are in notification journal 206 for tenant “4” and collection “5,” the notification entries can be stored in pages as Table 2 below.

TABLE 2
Notification Entry Storage

| Page ID | Page Key | Items | Expiration (seconds) |
|---|---|---|---|
| 1 | 4_5_1 | 1-100 | 7200 |
| 2 | 4_5_2 | 101-200 | 7200 |

The page key can be purged when the list of notification entries is not modified in the last time period specified by the “expiration” parameter. Data manager 204 can iterate through pages in notification cache 208 to acquire entries from a given notification handle to the last notification handle in notification cache 208. The last and most up-to-date notification handle can be maintained by a key Counter:<tenant_id><collection_id>.

Other keys stored in notification cache 208 can include a lock key Lock:<tenant_id><collection_id><page_id> for temporarily locking the key <tenant_id><collection_id><page_id> for modification. The locked key can be used to prevent conflicts in concurrent requests modifying a same key. Updates to the keys in notification cache 208 can be made through accessing the lock key first. Data manager 204 can acquire the lock key for a given collection and a page. Data manager 204 can then make the updates to data (e.g., inserting a new notification entry). Data manager 204 can delete the lock key after the update.

To retrieve notification entries (e.g., in response to the polling request), data manager 204 can construct a page key using a collection identifier and a notification handle. For example, when notification entries are stored using structure of Table. 2, data manager 204 can construct a page key having a value of 4_{—}5_{—}1 when the tenant identifier is “4,” the collection identifier is “5,” and the notification handle is less than or equal to a page size (“100” in the example above).

Data manager 204 can find page keys for a given collection (e.g., page keys 4_{—}5_{—}1 and 4_{—}5_{—}2 for collection “5”) if there are more than 100 notification entries in that collection. For each page key, data manager 204 can lock the page key, retrieve the notification entries, and unlock the key. Data manager 204 can aggregate the notification entries and get the latest notification handle from the counter key. For example, key Counter:4_{—}5 can correspond to a latest notification handle for collection having collection identifier “5.”

Application server 202 can send a notification in response to a polling request. The notification can include row IDs, event type associated with each row ID, and a notification handle. The row IDs part of the notifications can be inserted into paging cache 216. Paging cache 216 can be maintained by a paging framework. The notification handle can be associated with a query handle for paging to allow data manager 204 to update paged rows 214 stored in paging cache 216 for every notification. Client 104 can withhold from processing the notification if the notification does not directly affect a current page view. For example, a newly inserted row can be located at the end of the collection when the current page view is at the beginning of the collection.

A notification can be sent for an update made to a collection in database 108, including an update made to a row of data not being part of a result set of a query from client 104. Application server 202 can discard update and delete notifications that do not correspond to the result set. Application server 202 can use a query handle to identify a query that produced the result set, and to identify the result set produced by the query. Application server 202 can filter the notifications to exclude the row IDs not being part of the result set using a filtering mechanism. Application server 202 can store the row IDs internally using a data structure optimized for insertions and deletions (e.g., a tree list data structure). The filtering mechanism can be used for filtering the notifications based on event type, as specified by client 104. For example, the filter mechanism can be used to exclude notifications based on an insert event.

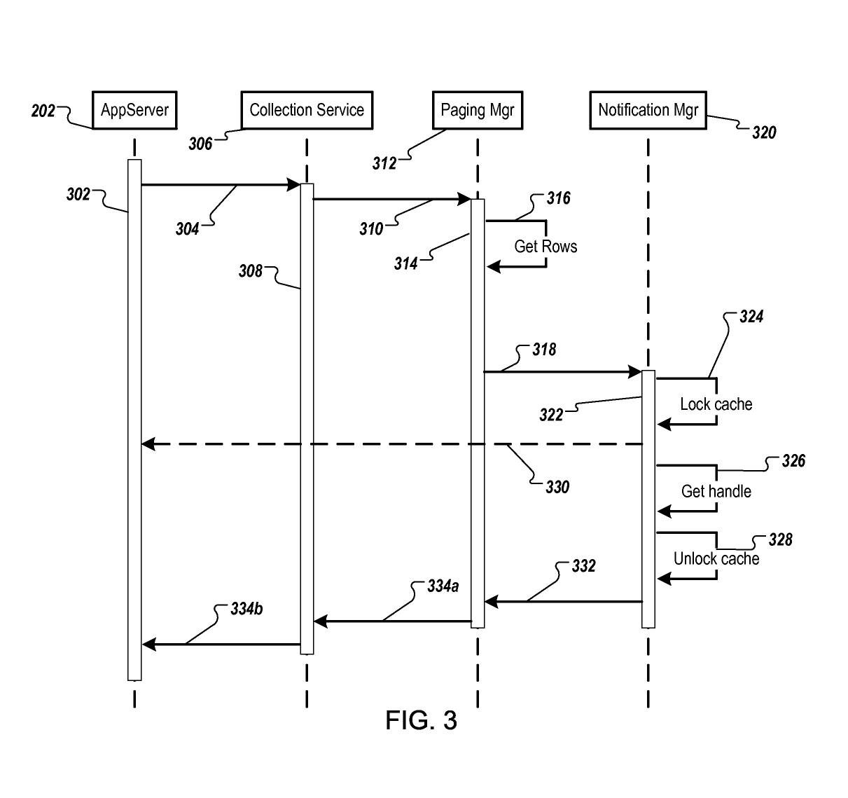

FIG. 3 is a sequence diagram illustrating interactions between various subsystems and processes during notification registration. Upon receiving a data request and a registration request from a client (e.g., client 102 or 104 of FIG. 1), application server 202 can invoke process 302 for processing the data request and the registration request.

Process 302, as well as other processes that will be described below, can include execution of a sequence of instructions of a function or a method or execution of a sequence of instruction of an application program. The processes can be independent processes managed by an operating system, or portions of one or more processes managed by an operating system. Process 302 can send message 304 to collection service 306. Collection service 306 can be a component of data manager 204. Collection service 306 can include a set of utilities for manipulating collections. Message 304, as well as other messages that will be described below, can include an instantiation of an object, or a function or method call. Message 304 can include information from the initial data request and other information. For example, message 304 can include a function call having parameters specifying a client identifier, a query, a tenant identifier, and query options. The tenant identifier can store a value that can identify a tenant, which can be a workgroup including one or more users. The query options can include an offset and a limit. The offset and limit can correspond to the offset and the number of records to retrieve, respectively, as specified in the initial data request.

Collection service 306 can delegate a task of responding to message 304 to paging manager 312. Upon receiving message 304, collection service 306 can invoke process 308 for retrieving a result of the query and notification information (e.g., a notification handle). Process 308 can send message 310 to paging manager 312. Paging manager 312 can invoke process 314 for processing the data request and the registration request. In response to the data request, process 314 can retrieve (316) rows of data in response to the query in the data request. In response to the registration request, process 314 can send message 318 to notification manager 320. Message 318 can include a tenant identifier, a client identifier, and a page identifier determined by paging manager 312 based on the query and query context.

Notification manager 320 can be a component of data manager 204. In response to message 318, notification manager 320 can invoke process 322 of determining a notification handle. Process 322 can lock (324) a page key using parameters of message 318, acquire (326) a notification handle, and unlock (328) the page key. If notification manager 320 detects an error (e.g., when a lock cannot be obtained), notification manager 320 can throw exception 330 to paging manager 312, collection service 306, or application server 202. If a notification handle is acquired, notification manager 320 can send the notification handle to paging manager in message 332.

Paging manager 312 can attach the notification handle in message 332 to the rows of data retrieved in stage 316 to create a result of process 314. The result can be send from paging manager 312 to application server in messages 334a and 334b.

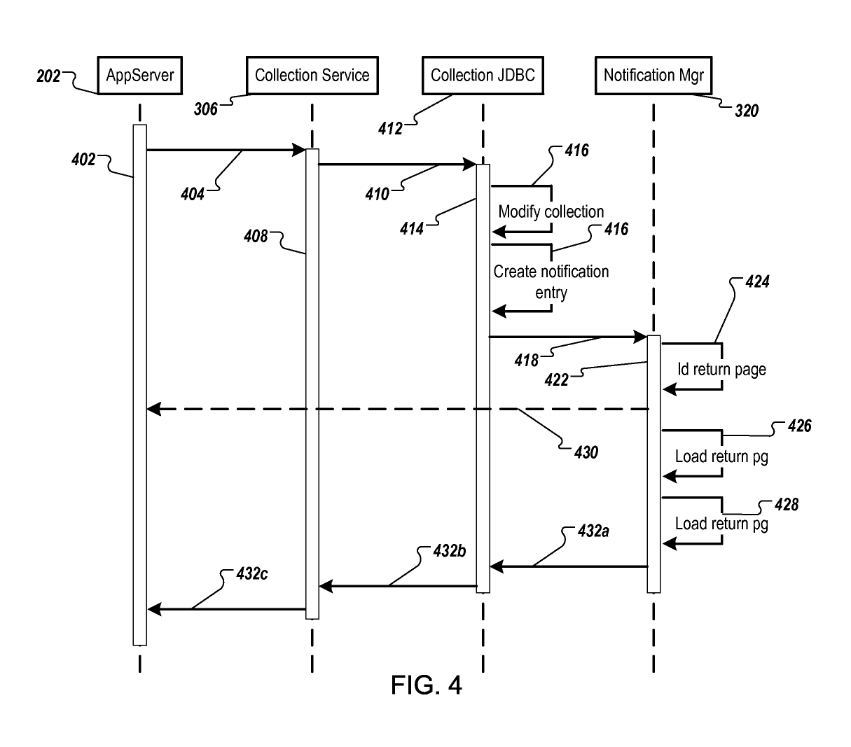

FIG. 4 is a sequence diagram illustrating interactions between various subsystems and processes upon occurrence of a notification event. A notification event can include an insertion, deletion, or update event. Upon receiving a request to modify a collection from a client (e.g., client 102 or 104 of FIG. 1), application server 202 can invoke process 402 for processing the request to modify the collection. The request to modify the collection can include a request to add a row of data, to delete a row of data, or to modify a row of data.

Process 402 can send message 404 to collection service 306. Message 404 can include information on the client (e.g., a client identifier) as well as information relating to the collection. The information relating to the collection can include a row ID if a row is to be deleted, a row ID and new data if a row is to be inserted or updated. Message 404 can include a function call to collection service 306.

Collection service 306 can invoke process 408 for modifying the collection. Process 408 can send message 410 to database interface 412. Database interface 412 can include a Java® database connectivity (JDBC) data access object (DAO) corresponding to the collection. Database interface 412 can invoke process 414 for processing the collection modification request. In response to the collection modification request, process 414 can modify (416) rows of data in the collection. Modifying rows of data in the collection can cause a new row count to be generated. Process 414 can create (417) a new notification entry. In addition, process 414 can send message 418 to notification manager 320. Message 418 can request notification manger 320 to add a notification entry to a notification journal for the client. Message 418 can include the newly created notification entry and a query context that includes a tenant identifier, a client identifier, and a page identifier.

In response to message 418, notification manager 320 can invoke process 422 of updating a notification journal. Process 422 can lock (424) a page key using parameters of message 418, update (426) the notification journal, and unlock (428) the page key. If notification manager 320 detects an error (e.g., when a lock cannot be obtained), notification manager 320 can throw exception 430 to database interface 412, collection service 306, or application server 202. If a notification handle is acquired, messages 432a, 432b, and 432c can be used to notify a process that a notification entry is successfully added to a notification journal.

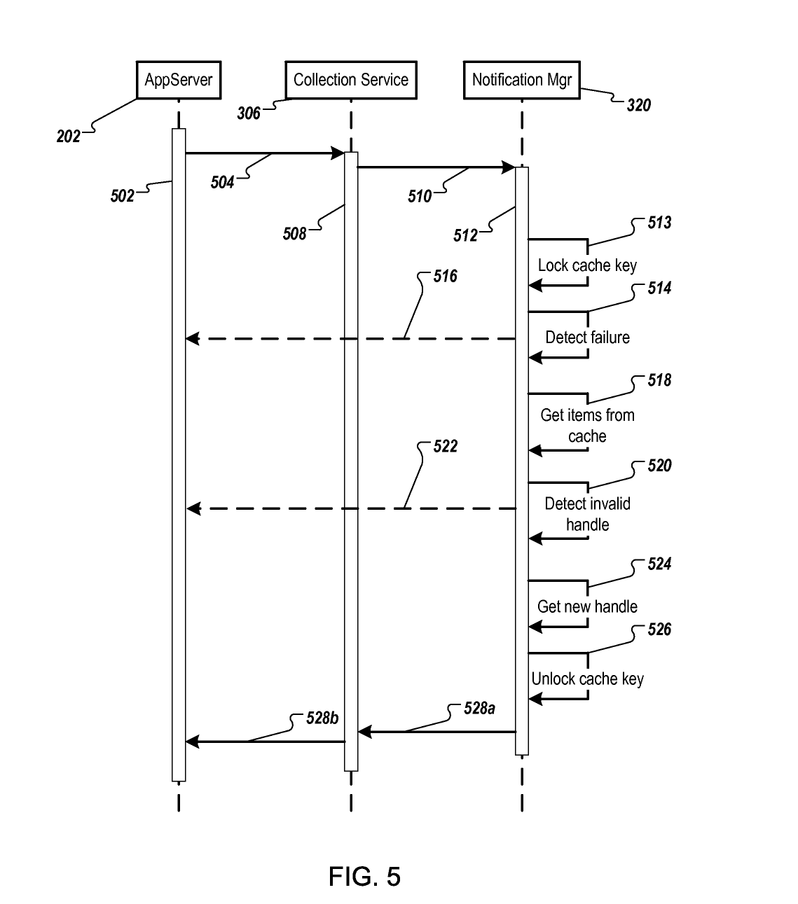

FIG. 5 is a sequence diagram illustrating interactions between various subsystems and processes in response to a client notification poll. Upon receiving a data request that includes notification poll from a client (e.g., client 102 or 104 of FIG. 1), application server 202 can invoke process 502 for processing the data request.

Process 502 can send message 504 to collection service 306. Message 504 can include a get collection row update request having parameters including a client identifier and a notification handle. Upon receiving message 504, collection service 306 can invoke process 508 for getting notification entries.

Process 508 can send message 510 to notification manager 320. Message 510 can include a get notification entry request, using the client identifier and notification handle as some of the parameters. In response, notification manager 320 can invoke process 512. In process 512, notification manager 320 can lock (513) a page key. Notification manager 320 can detect (514) if an error occurs. If the error occurs, notification manager 320 can throw exception 516 to collection service 306 or application server 202. If no error occurs, notification manager 320 can retrieve (518) from notification cache one or more notification entries using the page key and notification handle. Notification manager 320 can detect (520) whether the notification handle is valid. If the notification handle is invalid, notification manager 320 can throw exception 522 to collection service 306 or application server 202. If the notification handle is valid, notification manager 320 can retrieve (524) a new notification handle from the notification cache using the page key. Notification manager 320 can unlock (526) the page key and send the notification result, including the notification entries and the new notification handle, to collection service 306 and application server 202 in messages 528a and 528b.

### Exemplary Processes Implementing Collaborative Database Operations

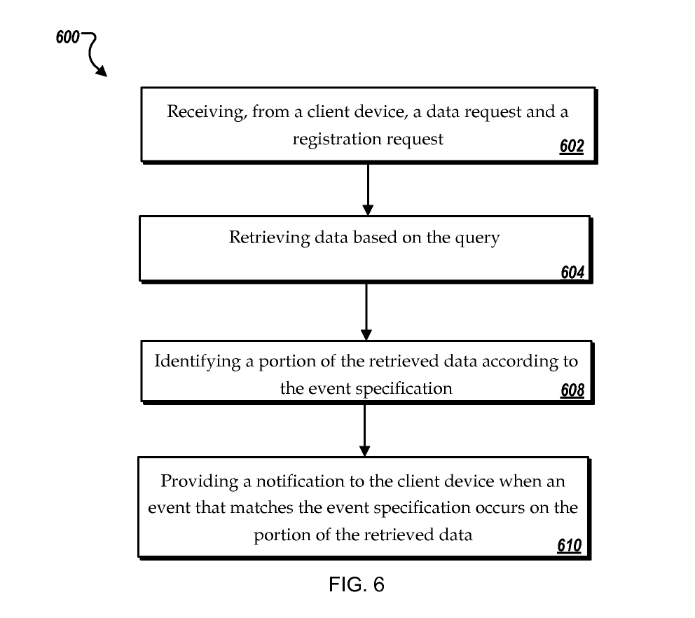

FIG. 6 is flowchart illustrating exemplary process 600 implementing collaborative database operations on a server. The server can include one or more data processing devices. The server can include application server 202 as described in FIG. 2.

The server can receive (602) a data request and a registration request from a client. The data request can include a query and a query context. The query can include a database query. The query context can include an identifier of the client and a data specification. The data specification can specify that, among a result set containing data retrieved in response to the query, a portion of the result set is to be sent to the client. Other portions of the result set can be sent to the client in response to a subsequent data request. The event specification can specify an event or event type to be registered for notification.

The server can retrieve (604) data from a relational database, from a flat file, or from any type of database (e.g., an object-oriented database) based on the query. Retrieving the data can include retrieving one or more data identifiers based on the database query. Each data identifier can be a row ID in a collection of the database. The collection can include data from one or more tables. Row IDs can be sent to the client, even if the data specification specifies that a portion of the rows of data are to be sent to the client. The row IDs can be stored in a paging cache on the server, and a data identifier buffer on the client. If a row of data identified by one of the row IDs is modified, or when a new row is inserted when the client is in a browse mode, the row ID of the modified or inserted row can be stored in a notification cache on the server. The row ID stored in a notification cache can be associated with a type of the event in a notification journal. The notification journal can correspond to the client identifier. Each client identifier can be associated to multiple notification journals.

The server can identify (606) a portion of the retrieved data according to the data specification. In the paging cache, the portion of data identified by the data specification can be marked. Identifying the portion of the retrieved data can include identifying the marked data in the paging cache of the server.

The server can provide (608) a notification to the client device when an event that matches the event specification occurs on the portion of the retrieved data. Providing the notification can include identifying an event causing a data value in a row of data to be changed or deleted. The row of data can be identified by one of the data identifiers in the notification journal. The event can be identified if the event has an event type as specified in the event specification. For example, the event can be identified if the event is an insertion event, deletion event, or update event, or any combination thereof, as specified in the event specification. In some implementations, providing the notification can include identifying a paged row of data in a paging cache using the data identifier. The paging cache can store the data identifier in association with information (e.g., a flag or marker) indicating that the row of data is currently being used by the client (e.g., being displayed at the client). If the information indicates that the row of data is currently being used, the server can incorporate the row of data in the notification. If the information indicates that the row of data is not currently being used, the server can incorporate the data identifier of the row of data in the notification. The server can send the notification to the client in response to a notification request from the client. In some implementations, providing the notification to the client can include providing the notification to update a retrieved result of the query without changing selection criteria of the query

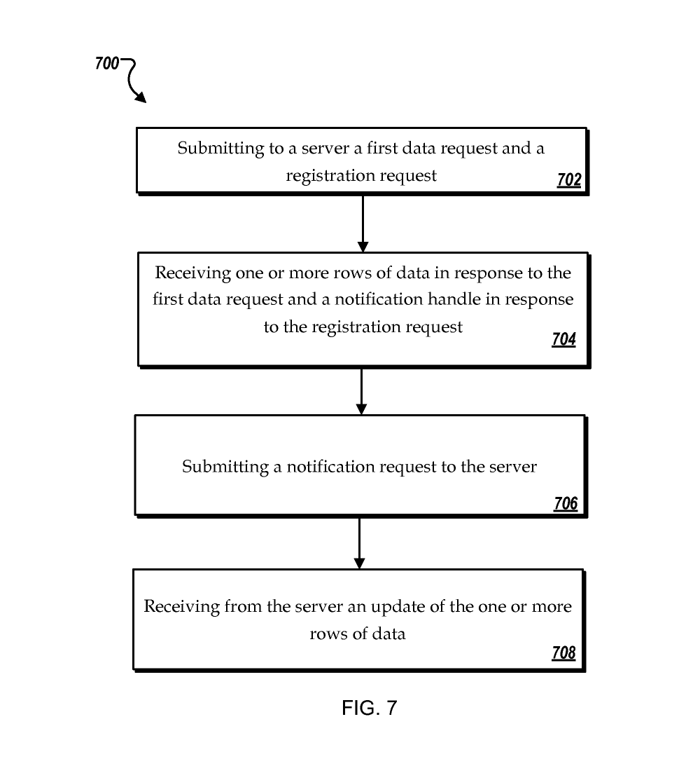

FIG. 7 is flowchart illustrating exemplary process 700 implementing collaborative database operations on a client. The client can include one or more data processing devices. The client can include client 102 or 104 as described above in reference to FIG. 1.

The client can submit (702) a data request and a registration request to a server. The data request can include a database query and a query context. The query context can include an identifier of the client and a data specification. The data specification can specify that, among a result set containing all data retrieved in response to the query, a portion of the result set (e.g., N data records from record offset M) is to be sent to the client. Other portions of the result set can be sent to the client in response to a subsequent data request. The registration request can identify a type of event upon occurrence of which a notification will be sent to the client. The type of the event can be at an insertion event, a deletion event, an update event, a schema event, an association event, or a combination of any of the above.

The client can receive (704) one or more rows of data in response to the data request and a notification handle in response to the registration request. The first rows of data can include the portion of the result set as specified in the query context. The notification handle can include a marker of a point in time after which a notification will be sent upon occurrence of an event having the identified type.

The client can submit (706) a notification request to the server. The notification request can include the notification handle. The notification request can be a polling request that is sent to the server periodically (e.g., every minute). Submitting the notification request to the server can include submitting the notification handle without submitting the database query.

The client can receive (708) from the server, in response to the notification request, an update of the one or more rows of data based on the notification handle. In addition, the client can receive from the server an update to the notification handle. The update to the notification handle can include a new point in time. The point in time can correspond to a time when a last event having the identified type occurred. The client can use the updated notification handle in subsequent notification requests.

In some implementations, process 700 can include receiving, from the server, one or more row identifiers identifying one or more second rows of data that are parts of a result set of the data query, the second rows of data currently not having been received by the client. The second rows of data can include, for example, rows of data currently not being displayed on a display device of the client. The client can store the one or more row identifiers in a data identifier buffer. The client can submit a paged data request to the server when the second rows of data are to be displayed. The paged data request can include the one or more row identifiers.

### Exemplary System Architecture

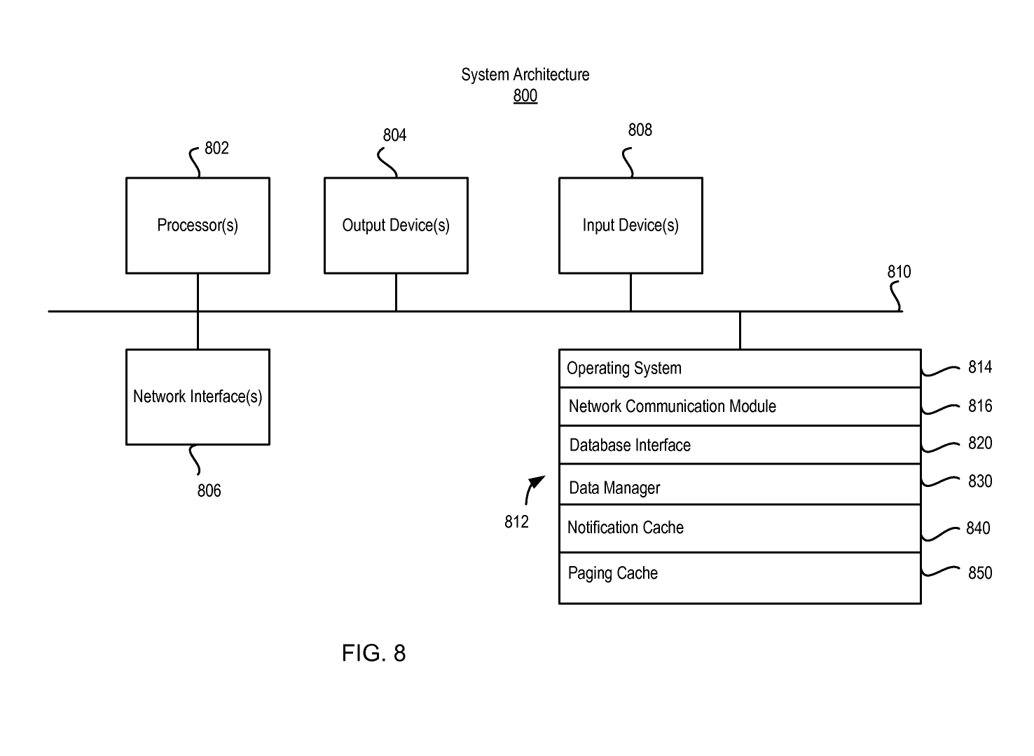

FIG. 8 is a block diagram of an exemplary system architecture 800 for implementing collaborative database operations. Other architectures are possible, including architectures with more or fewer components. In some implementations, architecture 800 includes one or more processors 802 (e.g., dual-core Intel® Xeon® Processors), one or more output devices 804 (e.g., LCD), one or more network interfaces 806, one or more input devices 808 (e.g., mouse, keyboard, touch-sensitive display) and one or more computer-readable mediums 812 (e.g., RAM, ROM, SDRAM, hard disk, optical disk, flash memory, etc.). These components can exchange communications and data over one or more communication channels 810 (e.g., buses), which can utilize various hardware and software for facilitating the transfer of data and control signals between components.

The term “computer-readable medium” refers to any medium that participates in providing instructions to processor 802 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 812 can further include operating system 814 (e.g., Mac OS® server, Windows® NT server), network communication module 816, database interface 820, data manager 830, notification cache 840, and paging cache 850. Database interface 820 can provide one or more user interfaces, interfaces between a server computer and a client computer, and interfaces between a relational database and another application program. Data manager 830 can perform various functions of notification in collaborative database operations, including functions for manipulating data stored in notification cache 840 and paging cache 850. Notification cache 840 can store one or more notification entries for notifying a client of data modification. Paging cache 850 can include one or more paging buffers on a server device, or one or more data identifier buffers or data record buffers on a client device.

Operating system 814 can be multi-user, multiprocessing, multitasking, multithreading, real time, etc. Operating system 814 performs basic tasks, including but not limited to: recognizing input from and providing output to devices 804 and 808; keeping track and managing files and directories on computer-readable mediums 812 (e.g., memory or a storage device); controlling peripheral devices; and managing traffic on the one or more communication channels 810. Network communications module 816 includes various components for establishing and maintaining network connections (e.g., software for implementing communication protocols, such as TCP/IP, HTTP, etc.). Database interface 820 can include interface to various databases including relational databases.

Architecture 800 can be included in any device capable of hosting a database application program. Architecture 800 can be implemented in a parallel processing or peer-to-peer infrastructure or on a single device with one or more processors. Software can include multiple software components or can be a single body of code.

The described features can be implemented advantageously in one or more computer program products that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube), LCD (liquid crystal display), or plasma monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations of the invention have been described. Nevertheless, it will be understood that various modifications can be made without departing from the spirit and scope of the invention. For example, polling mechanisms are described to illustrate implementations of notification. Pushing mechanisms can be utilized to implement the notifications in addition to or in place of the polling mechanisms. Accordingly, other implementations are within the scope of the following claims.

What is claimed is:

1. A method executed by one or more data processing devices, comprising:
receiving, from a client data processing device, a data request and a registration request, the data request including a query and a data specification, and the registration request including an event specification;
retrieving data based on the query;
identifying a portion of the retrieved data according to the data specification; and
providing a notification to the client data processing device when an event that matches the event specification occurs on the portion of the retrieved data.

2. The method of claim 1, where:
the query includes a database query;
the data specification specifies a portion of a result set of the database query; and
the event specification specifies at least one of an event or a type of event.

3. The method of claim 2, where retrieving the data includes:
retrieving one or more data identifiers based on the database query, each data identifier including a row identifier.

4. The method of claim 3, further comprising:
storing the one or more data identifiers in association with the type of event in a notification journal, the notification journal corresponding to a client identifier in the data specification.

5. The method of claim 4, where providing the notification comprises:
identifying an event causing a data value in a row of data to be changed or deleted, the row of data identified by one of the data identifiers in the notification journal, the event having the associated type; and
providing the notification to the client data processing device, the notification indicating that the data value in the row of data has changed, where the notification includes a notification handle identifying a point in time the event occurred.

6. The method of claim 5, where providing the notification to the client data processing device includes:
identifying a paged row of data in a paging cache using the data identifier, the paging cache storing information indicating whether the row of data is currently being displayed at the client data processing device;
if the information indicates that the row of data is currently being displayed, incorporating the row of data in the notification; and
if the information indicates that the row of data is not currently being displayed, incorporating the data identifier of the row of data in the notification.

7. The method of claim 1, where providing the notification to the client includes providing a notification to update a retrieved result of the query without changing selection criteria of the query.

8. A method executed by one or more data processing devices, comprising:
submitting to a server a data request and a registration request, the data request including a query and a query context, the registration request identifying a type of event upon occurrence of which a notification will be sent;
receiving one or more first rows of data in response to the data request and a notification handle in response to the registration request, the notification handle including a marker of a point in time after which a notification will be sent upon occurrence of an event having the identified type;
submitting a notification request to the server, the notification request including the notification handle; and
receiving from the server, in response to the notification request, an update of the one or more rows of data based on the notification handle, the updates resulting from the event.

9. The method of claim 8, further comprising:
receiving, from the server, one or more row identifiers identifying one or more second rows of data that are parts of a result set of the query, the second rows of data currently not having been received;
storing the one or more row identifiers in a data identifier buffer; and
submitting a paged data request to the server when the second rows of data are to be displayed, the paged data request including the one or more row identifiers.

10. The method of claim 8, where submitting the notification request to the server includes submitting the notification request periodically.

11. The method of claim 8, further comprising receiving from the server an update to the notification handle, the update to the notification handle including a new point in time.

12. The method of claim 11, where the point in time corresponds to a time when a last event having the identified type occurred.

13. The method of claim 8, where submitting the notification request to the server includes submitting the notification handle without submitting the query.

14. The method of claim 8, where the type of the event is an insertion event, a deletion event, an update event, a schema event, or an association event.

15. A computer program product stored on a storage device, operable to cause one or more processors to perform operations comprising:
receiving, from a client device, a data request and a registration request, the data request including a query and a data specification, the registration request including an event specification;
retrieving data based on the query;
identifying a portion of the retrieved data according to the data specification; and
providing a notification to the client in response to a notification request when an event that matches the event specification occurs on the portion of the retrieved data.

16. The product of claim 15, where retrieving the data includes retrieving one or more data identifiers based on the query, each data identifier including a row identifier.

17. The product of claim 16, the operations further comprising:
storing the one or more data identifiers in association with a type of event in a notification journal, the type of event being specified in the event specification, the notification journal corresponding to a client identifier in the data specification.

18. The product of claim 17, where providing the notification comprises:
identifying an event causing a data value in a row of data to be changed or deleted, the row of data identified by one of the data identifiers in the notification journal, the event having the associated type; and
providing the notification to the client device, the notification indicating that the data value in the row of data has changed, where the notification includes a notification handle identifying a point in time the event occurred.

19. A computer program product stored on a storage device, operable to cause one or more processors to perform operations comprising:
submitting to a server a data request and a registration request, the data request including a query and a query context, the registration request identifying a type of event upon occurrence of which a notification will be sent;
receiving one or more first rows of data in response to the data request and a notification handle in response to the registration request, the notification handle including a marker of a point in time after which a notification will be sent upon occurrence of an event having the identified type;
submitting a notification request to the server, the notification request including the notification handle; and
receiving from the server, in response to the notification request, an update of the one or more rows of data based on the notification handle, the updates resulting from the event.

20. A system comprising:
one or more computers configured to perform operations comprising:
receiving, from a client, a data request and a registration request, the data request including a query and a data specification, the registration request including and an event specification;
retrieving data based on the query;
identifying a portion of the retrieved data according to the data specification; and
providing a notification to the client in response to a notification request when an event that matches the event specification occurs on the portion of the retrieved data.
